(19) United States
(12) Patent Application Publication
(10) Pub. No.: US 2021/0352873 A1
(43) Pub. Date: Nov. 18, 2021

(54) Pet Training Device

(71) Applicant: Samantha Laskiewicz, Streamwood, IL (US)

(72) Inventor: Samantha Laskiewicz, Streamwood, IL (US)

(21) Appl. No.: 17/199,648

(22) Filed: Mar. 12, 2021

Related U.S. Application Data
(60) Provisional application No. 63/024,553, filed on May 14, 2020.

(51) Int. Cl. A01K 15/02

(52) U.S. Cl. CPC A01K 15/025; A01K 15/021

(57) ABSTRACT

A pet training device has a toy with an energizable pet interest feature. A throwing arm member has a distal end portion configured to releasably hold the toy and a proximal end portion configured to be gripped by the user for manipulating the throwing arm member. A winding mandrel is disposed on the throwing arm member intermediate of the proximal and distal end portions. A tether has one end connected to the toy and the opposite end connected to the winding mandrel. The tether being adjustable between an extended position and a retracted position. In the extended position, the tether extends from the distal end portion of the throwing arm member with the toy disengaged from the distal end portion of the throwing arm. In the retracted position, the tether is wound around the winding mandrel with the toy engaged with the distal end portion of the throwing arm member.

### RELATED APPLICATION DATA

This application claims the benefit of U.S. provisional application Ser. No. 63/024,553, filed on May 14, 2020, the disclosure of which is currently pending.

### BACKGROUND AND SUMMARY

The present disclosure is directed to a toy throwing and retrieving device for training a pet. The toy may be a ball or other object to generate interest for the pet in the event the pet becomes disinterested or the pet owner is training the pet to retrieve the toy.

More in particular, the disclosure is directed to a device for throwing the toy that includes a retrieval mechanism. The toy may be shaped to generate interest for the pet and may include a ball, fish, mouse, bone, bird, etc. The device includes a flexible shaft or throwing arm member having a distal end and a proximal end. A handle may be provided at the proximal end. The handle may be adapted and configured to allow the user to grip the device while throwing the toy. The handle may comprise material(s) to aid the user in gripping the device. The distal end of the device may include a holder portion or cradle that may be sufficiently resilient to releasably hold the toy in the holder portion until the sufficient forward momentum of the flexible shaft or throwing arm member during throwing motion causes the ball to be released from the holder portion. The throwing arm member may be retractable and extendable, for instance, telescopically or foldable.

Adjacent to the proximal end and intermediate of the proximal end and the distal end portions of the throwing arm member, a retrieval mechanism is provided. The retrieval mechanism may include a spool or mandrel connected to the flexible shaft. The spool may include a line or tether wound on the spool. One end of the line or tether may be connected to the toy and the other end may be connected to the spool or the flexible shaft depending upon the construction of the spool or mandrel.

When swinging the flexible shaft or throwing arm member in a forward circular path, the toy may be released from the holder portion at the distal end portion of the throwing arm, and the line or tether may be released from the spool. The spool may be configured to pay the line out in an orderly fashion without tangling. In the event the pet fails to retrieve the toy, the line or tether may be wound up on the spool and the tether retracted to bring the toy back to the user. The spool may be, or similar, to a reel commonly used on a fishing rod. The spool may also be adapted and configured to allow the line to be loosely wound around a mandrel. The spool may include winding the line loosely about itself so as to allow the line to be paid out in an orderly fashion without tangling. The line or tether may be constructed of a material that would not harm the pet if the line comes into contact with the pet but provide sufficient strength to allow throwing the toy and moderate force of pulling exerted by the pet when engaging the toy.

The toy may be releasably connected to the line to allow the toy to be removed and replaced as needed, or to allow the pet to remove the toy from the line, for instance, to prevent snapping the tether and/or allow the pet to bring the toy back directly to the user.

The toy may be equipped with an energizable pet interest feature. The energizable pet interest feature may be a light, vibrator and/or sound generator. The energizable pet interest feature may be energized by a power source arranged on the toy, for instance, a battery, which may be fixed and/or removable from the toy, and/or rechargeable by charging from a household power supply. The energizable pet interest feature may be selectively energizable. The pet training device may further include a remote control adapted and configured to be in communication with the toy and selectively control energization of the energizable pet interest feature.

### DESCRIPTION OF THE DRAWINGS

FIG. 1 is a perspective view of a pet training device;

FIG. 2 is a side view of the pet training device of FIG. 1;

FIG. 3 is a schematic representation of a method of using the pet training device of FIG. 1; and

FIG. 4 is a schematic representation of a toy of the pet training device.

### DETAILED DESCRIPTION

The exemplary pet training device 10 has a toy 12 having a energizable pet interest feature 14. The toy 12 is thrown during use by manipulating a throwing arm member 16. The throwing arm member 16 has a distal end portion 18 and proximal end portion 20. The distal end portion 18 is adapted and configured to releasably hold the toy 12. The proximal end portion 20 may be adapted and configured to be gripped by the user to enable the user to manipulate the throwing arm member and may include an ergonomic handle. A winding spool or mandrel 22 may be operatively connected to the throwing arm member 16 intermediate of the proximal and distal end portions 18,20 of the throwing arm member.

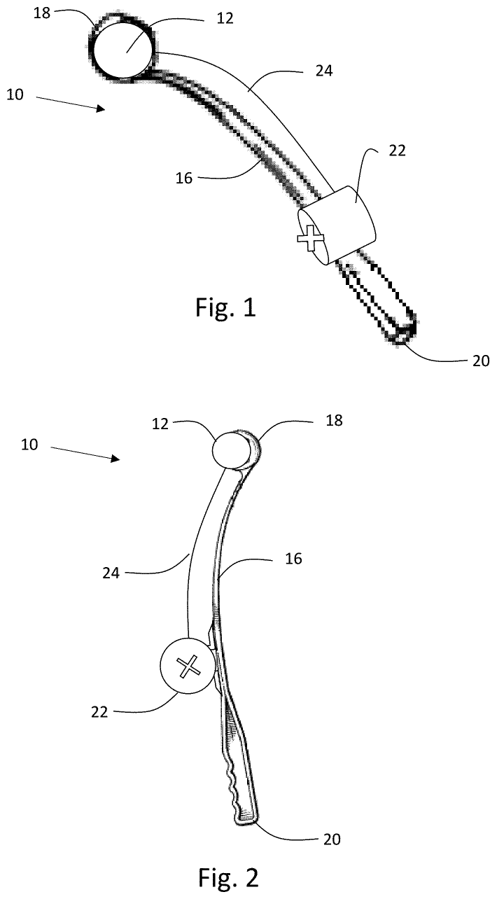

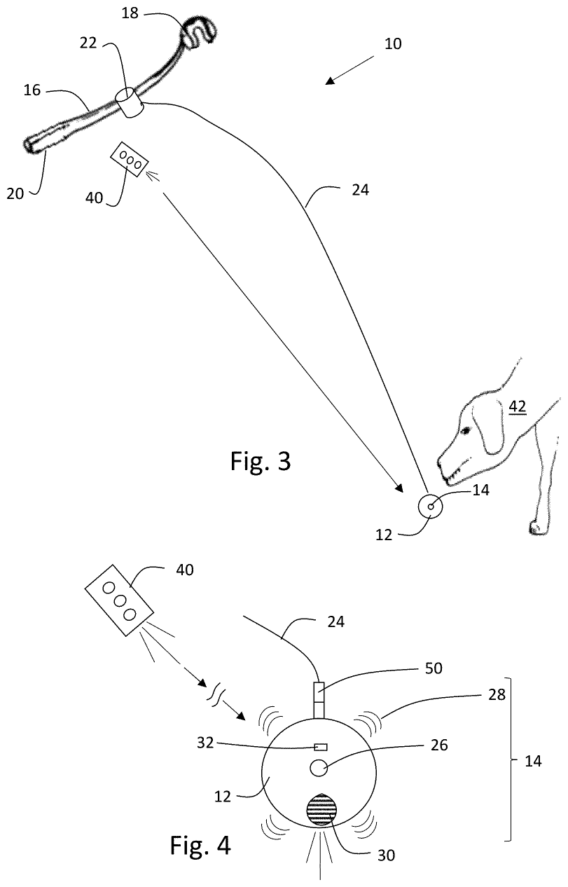

A tether 24 may be provided with one end of the tether connected to the toy 12 and the opposite end of the tether operatively connected to the winding spool or mandrel 22. During use of the pet training device, the tether 24 may be paid out to an extended position and retracted to a retracted position. In the extended position (e.g., FIG. 3), the tether may extend from the distal end portion 18 of the throwing arm member 16 with the toy 12 disengaged from the distal end portion of the throwing arm. As discussed above, the throwing arm member 16 may be manipulated to throw the toy 12 and pay out the tether 24 from the mandrel or spool 22 to the extended position of the tether. In the retracted position (e.g. FIGS. 1 & 2), the tether 24 is wound around the winding mandrel or spool 22 with the toy 12 engaged with the distal end portion 18 of the throwing arm member 16.

The toy 12 of the pet training device may include an energizable pet interest feature 14. The energizable pet interest feature 14 may include at least one of a light 26, a vibrator 28, and a sound generator 30. The energizable pet interest feature 14 may be energized by a power source 32 arranged on the toy, for instance, a battery, which may be fixed and/or removable from the toy, and/or rechargeable by charging from a household power supply. For instance, the battery may be removed from the toy and recharged at a recharging station away from the toy so that once the battery is charged, it may be reinstalled in the toy. In the alternative, the battery may be fixed in the toy and recharged by accessing an electrical charging port on the toy, for instance, as shown in FIG. 4.

The energizable pet interest feature 14 may be selectively energizable. The pet training device may further include a remote control 40 adapted and configured to be in communication with the toy and selectively control energization of the energizable pet interest feature. For instance, if the pet 42 is disinterested with the toy 14 after the toy has been thrown, the user may energize one or more of the selectively energizable pet interest features 26,28,30 in an effort to reengage the pet and have the pet interact with the toy via the remote control 40. The remote control 40 may have one or more controls for energizing any one of the selectively energizable pet interest features 26,28,30. Alternatively, if the toy 14 becomes disconnected from the tether 24 after being thrown, the user may energize one or more of the selectively energizable pet interest features 26,28,30 in an effort to locate the toy. The toy 14 may be releasably connected to the tether 24 with a coupling 50 that is adapted and configured to remain connected when throwing the toy with the throwing arm member 16 but may be disconnected when moderate force is applied to the toy and tether. For instance, the coupling may be magnetic or comprise interlocking tabs and slots. The coupling 50 allows the toy 12 to be disconnected from the tether 24 for replacement of the toy or tether. In addition to or the alternative, the coupling 50 allows the pet to be disconnect to the toy 12 so as to allow the pet to bring the toy directly to the user without the user needing to wind the tether 24.

In using the pet training device, the user may access the pet training device, and manipulate the throwing arm member 16 in a manner to release the toy 12 from the distal end portion 18 of the throwing arm member, extend the tether 24 from the distal end portion of the throwing arm member, and unwind the tether from the winding mandrel 22. Then the user may selectively energize the energizable pet interest feature 14 as desired to train the pet 42. The user may selectively energize the energizable pet interest feature 14 repeatedly in order to engage the pet to the extent the pet is not or loses interest in the toy 12. Once training is complete or if the pet no longer has interest in the toy, the user may wind the winding mandrel 22 in a manner to retract the tether 24, wind the tether around the winding mandrel, and to engage the toy with the distal end portion 18 of the throwing arm member 16.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

What is claimed is:

1. A pet training device comprising:
a toy having a energizable pet interest feature;
a throwing arm member having a distal end portion and proximal end portion, the distal end portion being adapted and configured to releasably hold the toy, the proximal end portion being adapted and configured to be gripped by the user and enable the user to manipulate the throwing arm member;
a winding mandrel operatively connected to the throwing arm member intermediate of the proximal and distal end portions of the throwing arm member; and
a tether, one end of the tether being connected to the toy, the opposite end of the tether being operatively connected to the winding mandrel, the tether being adjustable between an extended position and a retracted position, wherein in the extended position, the tether extends from the distal end portion of the throwing arm member with the toy disengaged from the distal end portion of the throwing arm; wherein in the retracted position, the tether is wound around the winding mandrel with the toy engaged with the distal end portion of the throwing arm member.

2. The pet training device of claim 1 wherein the energizable pet interest feature of the toy is a light.

3. The pet training device of claim 2 wherein the light is energized by a power source arranged on the toy.

4. The pet training device of claim 2 wherein the light is selectively energizable.

5. The pet training device of claim 4 further including a remote control adapted and configured to be in communication with the toy and selectively control energization of the light.

6. The pet training device of claim 1 wherein the energizable pet interest feature of the toy is a vibrator.

7. The pet training device of claim 6 wherein the vibrator is energized by a power source arranged on the toy.

8. The pet training device of claim 7 wherein the vibrator is selectively energizable.

9. The pet training device of claim 8 further including a remote control adapted and configured to be in communication with the toy and selectively control operation of the vibrator.

10. The pet training device of claim 1 wherein the energizable pet interest feature of the toy is a sound generator.

11. The pet training device of claim 10 wherein the sound generator is energized by a power source arranged on the toy.

12. The pet training device of claim 10 wherein the sound generator is selectively energizable.

13. The pet training device of claim 12 further including a remote control adapted and configured to be in communication with the toy and selectively control operation of the sound generator.

14. A method of training a pet comprising:
accessing a pet training device; wherein the pet training device has: (i) a toy with an energizable pet interest feature, (ii) a throwing arm member with a distal end portion and proximal end portion, the throwing arm distal end portion is adapted and configured to releasably hold the toy, the throwing arm proximal end portion is adapted and configured to be gripped by the user and enable the user to manipulate the throwing arm member; (iii) a winding mandrel operatively connected to the throwing arm intermediate of the proximal and distal end portions of the throwing arm, and (iv) a tether with one end of the tether connected to the toy, the opposite end of the tether operatively connected to the winding mandrel; and
manipulating the throwing arm member in a manner to release the toy from the distal end of the throwing arm member, extend the tether from the distal end portion of the throwing arm member, and unwind the tether from the winding mandrel;
selectively energizing the energizable pet interest feature;
winding the winding mandrel in a manner to retract the tether, wind the tether around the winding mandrel, and to engage the toy with the distal end portion of the throwing arm member.

15. The method of claim 14 wherein the step of selectively energizing the energizable pet interest feature includes selectively energizing at least one of a light, a vibrator, and a sound generator.

16. The method of claim 15 wherein the step of selectively energizing the at least one of the light, the vibrator, and the sound generator includes using a remote control in communication with the toy.

17. The method of claim 15 wherein the step of selectively energizing the energizable pet interest feature includes repeatedly selectively energizing the energizable pet interest feature when a pet fails to interact with the pet training device.
